(19) United States
(12) Patent Application Publication
(10) Pub. No.: US 2013/0306524 A1
(43) Pub. Date: Nov. 21, 2013

(54) UNDERWATER GOLD PROCESSING MACHINE

(71) Applicant: Michael Dudley Welch, Camdenton, MO (US)

(72) Inventor: Michael Dudley Welch, Camdenton, MO (US)

(21) Appl. No.: 13/476,592

(22) Filed: May 21, 2012

(51) Int. Cl. B03B 5/56; B63G 8/14

(52) U.S. Cl. 209/10; 114/313

(57) ABSTRACT

A remotely controlled submersible gold ore processor operated on the ocean floor for the off-shore mining of fine gold in shallow to moderate depth water. This remotely-operated gold processor is powered by multiple hydraulic motors, with each motor performing its assigned duty, while the gold processor is driven along the ocean floor.

### REFERENCES CITED

### U.S. Patent Documents

| | | | |
|---|---|---|---|
| 4,398,362 | August 1982 | Weinert | Oceanic Seaplow System |
| 3,588,174 | August 1969 | Rossfelder, Thorn | Collector Assembly For Deep Sea Mining |
| 3,672,725 | June 1970 | Johnson | Deep Sea Mining Method And Apparatus |
| 6,178,670 | January 1997 | Susman, Stewart | Underwater Mining Apparatus |
| 3,905,137 | February 1974 | Gee | Underwater Tractor And Implement Thereof |
| 6,003,952 | March 1998 | Smart, et al | Underwater Mining Machine |
| 3,731,975 | November 1971 | Lindelof | Apparatus And Process For Undersea |
| | | | Mining Of Mineral Bearing Sand And Gravel |
| 4,681,372 | February 1986 | McClure | Deep Sea Mining Apparatus |
| 4,685,742 | February 1985 | Moreau | Equipment For Extracting Gold Ores From |
| | | | Sea Beds |
| 3.950,030 | April 1976 | Girden | Underwater Mining |
| 4,311,342 | October 1978 | Latimer | Dredge Head With Mechanical And Pumping |
| | | | Action |
| 4,232,903 | December 1978 | Welling, et al | Ocean Mining System And Process |

### BACKGROUND OF THE INVENTION

### Invention Field

This invention relates generally to shallow water, off-shore gold ore prospecting on the sea floor. My invention may replace the conventional method of offshore prospecting where a diver with a suction hose on the sea floor, suctions loose sea floor material to a floating dredge above.

All inventions relating to sea floor mining have in common the one central purpose, which is to gather the mineral or gold bearing ore. How they go about this process is what distinguishes one invention from another.

Virtually all offshore gold mining processes rely on a support vessel to process the gold rich ore transported to it from some machine located on the sea floor below. My invention conforms to this common practice, as it does require a floating work platform on the waterway's surface, which is usually referred to as a dredge. See U.S. Pat. Nos. 3,905,137, 6,178,670, 4,681,372, 3,950,030, 4,398,362, 6,003,952, 3,731,975, 3,672,725, 4,232,903, 3,588,174, 4,685,742, & 4,311,342 as examples of mining machines that require the use of typical support vessels.

Many underwater mining vehicles have a means of forward movement, with crawler style tracks being one of the most popular methods of sea floor locomotion, as displayed by U.S. Pat. Nos. 4,685,742, 3,672,725, 3,731,975, 6,003,952, 6,178,670, & 3,905,137. Obviously, crawler style track propulsion is one of the more common methods of underwater mining-machine mobility. My invention conforms to this familiar means of locomotion.

Underwater machines gather the sea floor material, rich in gold bearing ore, usually by one of two primary methods. First, some machines use some type of suction head or device, as displayed in U.S. Pat. Nos. 4,681,372, 3,950,030, 4,685,742, & 3,588,174. Or second, other machines may use a collection method with some sort of scoops or paddles, such as U.S. Pat. Nos. 4,685,742, 3,672,725, 4,398,362 or 3,731,975.

At this point, it should be pointed out that all inventions thus listed are presumed to operate in deep water environments only. In fact, an exhaustive prior art patent search does not reveal any shallow water, remotely operated, prospecting machines designed specifically for water depths as shallow as 2 meters, which my invention is fully capable of operating in.

Generally, one of the limiting factor of shallow water prospecting has been the necessary size of the support vessel for the machine's retrieval. Undoubtedly, a machine that weighs a few thousand pounds requires a large ship to lift it. This scenario creates another limiting factor, too, since a ship large enough to lift such a heavy machine, is also too large to be operated in shallow water. Therein lies a distinguishing feature of my invention that separates it from prior art. The unique feature of my invention that overcomes this quandary will be revealed in the summary section.

Prior art in the field of gold prospecting has many facets. There is open-pit mining, stream gold panning, underground tunneling, and deep sea prospecting, to name a few. However, when one narrows the field specifically to shallow water mining known as dredging, the prior art appears to be limited to either a human diver with a simple suction hose from a floating dredge, scouring the sea bed for material, or a dry land style, diesel powered excavator mounted on a barge.

The excavator mounted on a barge has its obviously limitations, such as the need for a huge floating platform to support the tremendous weight of the excavator, and its limited depth of reach. In any event, the floating excavator method of shallow water mining is beyond the scope and comparison of my invention.

The fundamental differences in the designs of prior art are largely due to:
a) the composition of sea floor material expected to be processed
b) the depth of having to retrieve that material
c) the method of how the material is refined and sent to the support vessel on the water's surface

Prior art of shallow water gold prospecting, relating more closely to my invention, is limited to a human diver, working in conjunction with a dredge, on the sea floor. My invention has the ability to replace this diver, and increase his productivity with much greater success.

Mining natural resources successfully, regardless of the method chosen, requires processing as much ore as possible in a given time period. It is as simple as that. The more ore processed, the more of a desired resource is obtained. As is often the case, and certainly with my invention, when a human laborer is replaced with a multi-functional machine, productivity is usually greatly enhanced.

### SUMMARY OF THE INVENTION

Specified in detail, the invention includes the following:
a) a chassis mounted to a remotely powered set of crawler tracks, each operating independently, and each track being capable of operating in at least one direction
b) a forward mounted, horizontally oriented, counter-rotating set of blades, affixed to an axle shaft, mounted to a set of lifting arms; wherein said counter-rotating set of blade's function is to clear a path of large unwanted rocks and boulders
c) a conveyor belt of continuously revolving scoops, to capture and transfer for further processing the dirt and material gathered on the sea floor, which has been cleared of any unwanted large rocks or boulders by said counter-rotating set of blades
d) a rotating mesh-walled drum, commonly known as a trommel, whose purpose is to classify the delivered material from said continuously revolving scoops, by allowing the sought-after gold ore to fall through its mesh openings to a point for capture, and discard the unwanted rocks rearward of the vehicle's path
e) a solid surface, stationary shield encompassing much of the lower and side portions of said mesh-walled drum, which includes in its design a screw conveyor, which is set in a trough, and whose rotation is such that it conveys said gold ore and fine material to a discharge hole located at the aft bottom portion of the trough, where said gold ore falls through said discharge hole
f) an external suction fixture, encompassing said discharge hole of the screw conveyor trough, wherein an attached suction hose can transfer said gold ore and fine material to the floating dredge above, for further processing to refine out the gold particles and flakes
g) one or more inflatable apparatuses, mounted at strategic locations on the main chassis, for the express purpose of adding significant buoyancy to the machine when inflated, thereby easing the machine's retrieval by the support vessel
   It is expected that the machine may have the following attributes, but not be limited to only the following listed items:

The machine may have a set of crawler style tracks, however, different means of mobility are certainly considered, such as wheels, which may be mounted longitudinally in the direction of the vehicle's travel, each means operating independently, and both having the ability of at least one direction of motion.

The machine may have numerous hydraulic, fluid or air driven motors, each with a means for transferring its rotational energy, along with other hydraulic, fluid or air controlled devices, to operate said vehicle's various and sundry motions.

The machine is expected to operate in a forward progressive motion, in conjunction with a support vessel on the water's surface. It is further an object of this invention that at least one suction hose, along with numerous hydraulic hoses and air lines, will attach to said machine, and trail back to said support vessel.

The front set of counter-rotating blades may be mounted in a transverse manner to the machine's forward direction of movement, in a horizontal fashion, with a width dimension sufficiently wide enough to displace large rocks out of the track's path. Although counter-rotating blades are suggested, it is also contemplated, and an object of my invention that an oscillating forward and rearward thrusting apparatus could accomplish the same process.

The supporting arms for the counter-rotating set of blades may be hydraulically lowered or raised.

The machine may have a continuously revolving set of scoops to gather sea floor material for processing. Scoops are the preferred means for gathering said sea floor material, but it is envisioned paddles or shovels are also a consideration of my invention.

Material gathered by the revolving set of scoops may be delivered to a mesh-walled rotating drum for processing small desired ore separated from large unwanted gravel, a process known as classification. Classification, referring specifically to natural soil, is the separation of its constituent members into different groups of like-sized material.

As presently embodied, my invention includes a rotating mesh-walled drum, but it is not my intention to exclude other material classifiers that can accomplish the same function. These other styles of classifiers, such as grids, shaker screens, or sifters, are a consideration of my design.

Said rotating mesh-walled drum may allow said sought-after gold ore to fall through its mesh openings and this ore may settle on a stationary outer shield.

It may be pointed out that said mesh openings of said rotating mesh-walled drum may have a means for a range of different mesh opening sizes. Said different mesh opening sizes may be by way of, but not limited to, drop-in replacement panels, or entirely replacing said rotating mesh-walled drum.

Said stationary outer shield may be designed in such a way that it parallels at least part of said rotating mesh-walled drum's outer circumference, and it incorporates in its shape provisions for a screw conveyor, which is set in a trough. One or more wiper blades mounted lengthwise on said mesh-walled drum's outer surface may sweep said gold ore into said screw conveyor's trough.

Said screw conveyor, commonly referred to as an auger, which may have a flexible spiraling blade edge, situated in said trough, positioned below said mesh-walled rotating drum, may rotate in such a manner that said gold ore may be spirally directed rearward to drop through a discharge hole.

The machine may include a discharge hole at the bottom aft portion of said screw conveyor's trough to allow for the suctioning of said gold ore through an externally mounted device, wherein a suction hose may be attached to transfer said gold ore to the support vessel on the water's surface for further processing.

The machine may have a central support chassis to which all other members are attached.

At the end of a work-day of processing, the operator of the support vessel may cause the inflatable apparatus affixed to the machine to become inflated via a compressed air line from the support vessel, thereby greatly increasing the machine's buoyancy, therein allowing the support vessel to more easily winch the machine into its cradle dock. It is expected that this inflatable apparatus may increase the machine's buoyancy by a significant amount.

Among the various inflatable apparatuses contemplated, and are considered an object of my invention are: bellows, bladders, balloons, airbags, or any other apparatus such that when pressurized air is introduced to its interior, the apparatus will inflate and become more buoyant. The previous list of expandable bellows is not to suggest my invention may not also include other means to achieve buoyancy, such as solid-walled tanks, closed containers, drums, or any other sealed container such that when pressurized air is introduced to its interior it may add buoyancy to said machine.

Underwater lights and video cameras may be mounted on my invention to assist the dredge operator in monitoring the machine's performance.

These features thus mentioned, along with other features, will be made apparent from the detailed embodiment of the images contained herein. In the description references, match the corresponding number with those shown in FIGS. 1-9, but it should be noted that specific features referenced in the drawings should not be construed or intended as limiting the invention. It is also not implied that a specific feature or design alteration not listed is not included in a workable model.

### BRIEF DESCRIPTION OF THE DRAWINGS

FIG. 1 shows an elevated, right front embodiment of the invention

FIG. 2 shows an elevated, left rear embodiment of the invention

FIG. 3 shows an elevated, left rear close-up embodiment of the invention, with a cutaway view showing the inner workings of the screw conveyor and trough

FIG. 4 shows an embodiment of the invention as viewed from the front

FIG. 5 shows an embodiment of the invention as viewed from the rear

FIG. 6 shows an embodiment of the left side of the invention, with an inflated view of the inflatable apparatus

FIG. 7 shows an embodiment of the right side of the invention

FIG. 8 shows a plan embodiment of the invention

FIG. 9 shows a pictorial embodiment of the invention in use, accompanied by the support vessel. An enlarged image of the assorted hydraulic hoses, air lines, and a suction hose is depicted by section line A

### DESCRIPTION OF THE DRAWINGS OF THE INVENTION

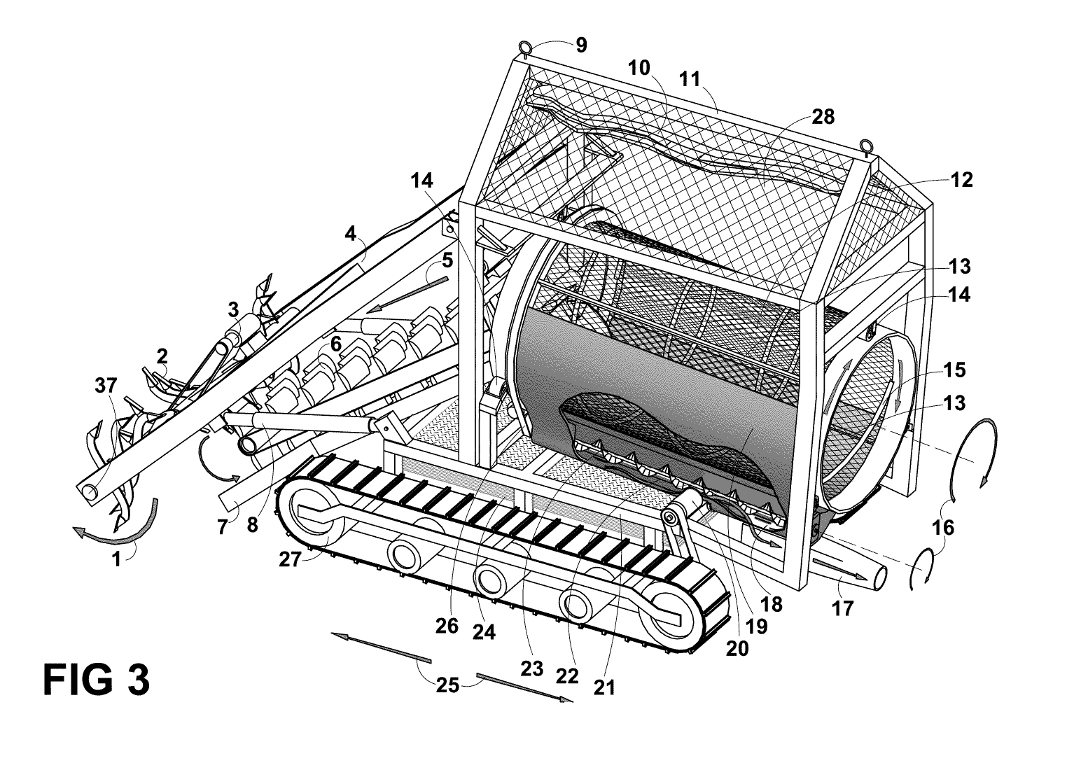

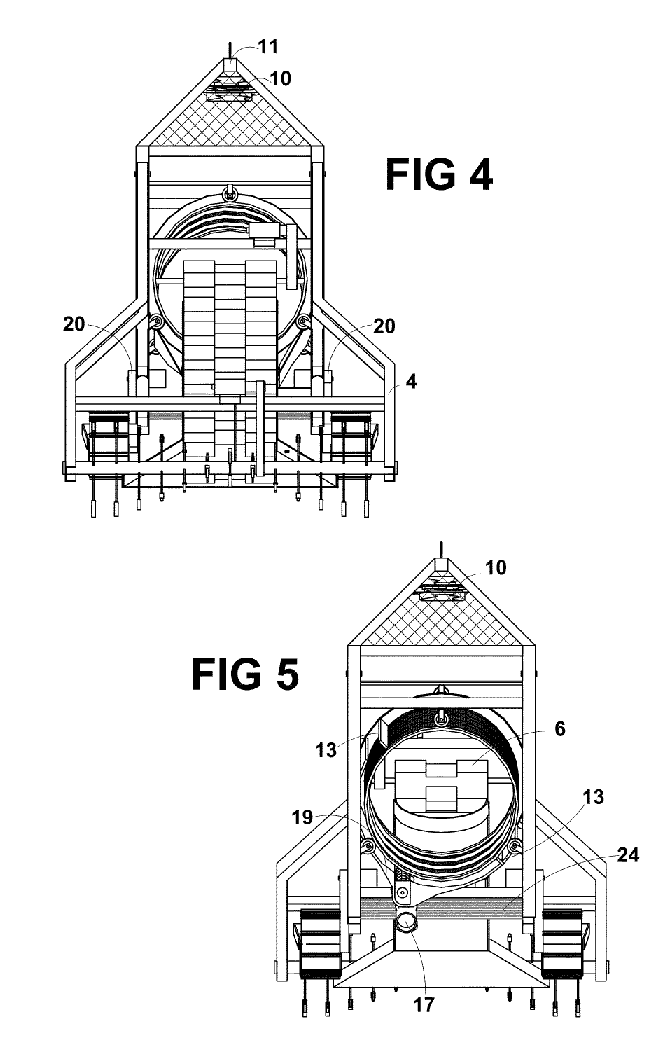

In the drawings, a preferred embodiment of the invention of a shallow-sea gold mining processor is best illustrated in FIG. 3. FIG. 3 has a cutaway view of the stationary shield 19, which helps shows the inner workings of the screw conveyor 23. FIG. 2 embodies FIG. 3, except the cutaway view is removed.

Referring to FIG. 3, the machine is comprised of a chassis 21 which is mounted on a set of tracks 27, driven by a motor and a means to convey rotational energy 20 per each track, which can be driven in direction 25.

The machine has a front mounted, counter-rotating set of blades 2, helically affixed to an axle shaft 37 that rotates in the direction 1, driven by a motor and a means to convey rotational energy 3.

Said rotational direction 1 of said counter-rotating set of blades 2, coupled with the helical mounting positions of said counter-rotating set of blades 2, has the effect of dislodging and knocking unwanted boulders ahead of the machine, and the successive blows of said counter-rotating set of blades 2 will laterally knock said unwanted boulders out of said machine's pathway.

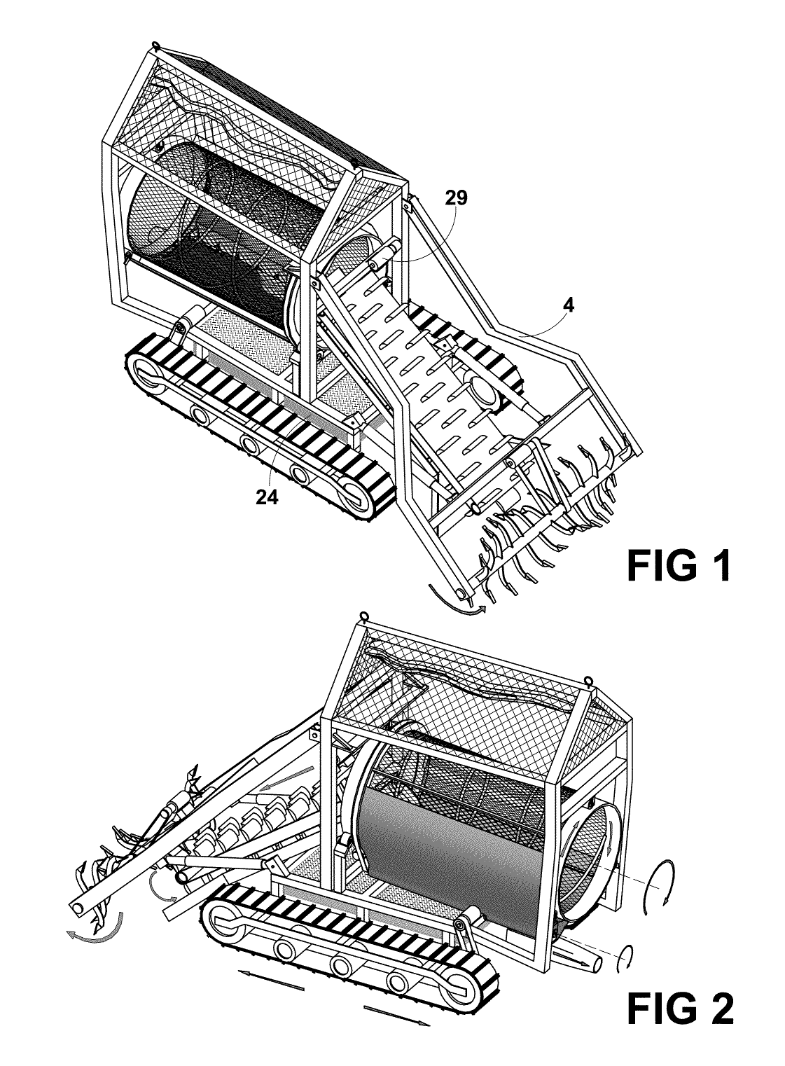

FIG. 1 best embodies the helical mounting positions of said counter-rotating set of blades 2. Referring to FIG. 1, if one can envision said counter-rotating set of blades 2 rotating in said direction 1 (FIG. 3), one may also envision the left outward corkscrewing effect of the left side blades, and the right outward corkscrewing effect of the right side blades, of the centermost blade.

Referring again to FIG. 3, said counter-rotating set of blades 2, solidly mounted to said axle shaft 37, are mounted to a lifting arm assembly 4, which is in turn, pivotally mounted to the chassis 21 by way of vertical frame members of said chassis 21. Said lifting arm assembly 4 and said attached front assembly of counter-rotating set of blades 2 may be raised or lowered by hydraulic cylinders 8.

It is an object of my invention that the front set of counter-rotating blades 2 be sufficiently wide enough to direct rocks and boulders laterally clear of said track's 27 pathway.

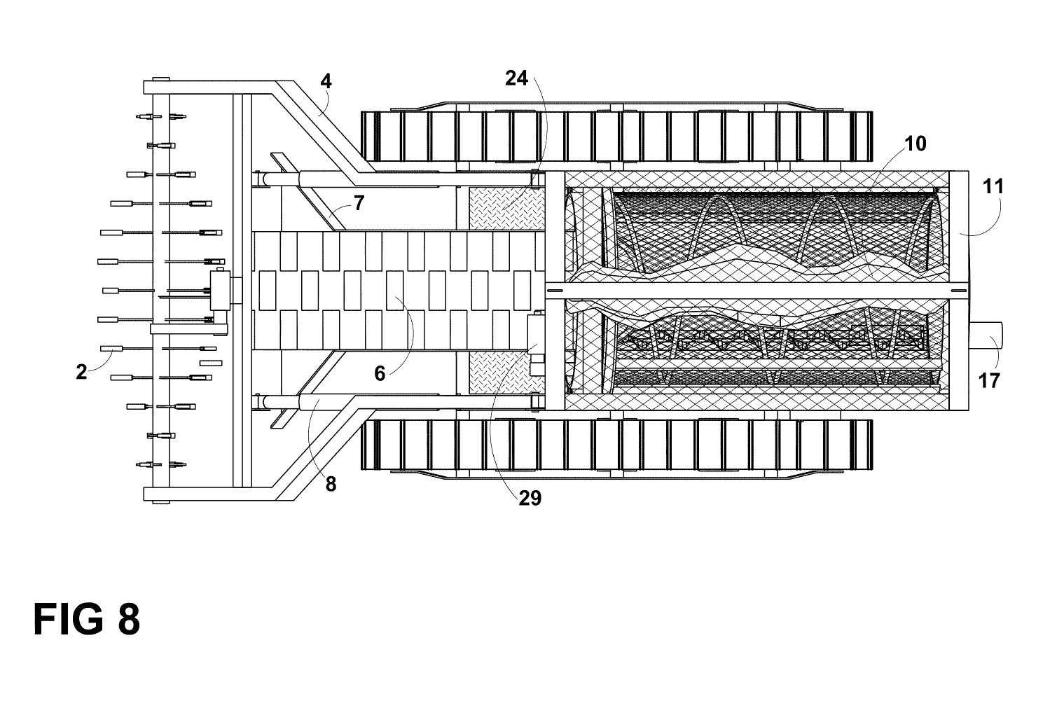

After the sea floor material is cleared of any unwanted boulders by said counter-rotating set of blades 2, and by the machine's forward motion, the conveyor belt of scoops 6, revolving in the direction 5, powered by a motor and a means to convey rotational energy 29 (FIG. 8) gathers said sea floor material, and pull this desired said sea floor material up ramp 7. Ramp 7 may have a leading cutting edge that is adjustable in length, thereby giving ramp 7 an adjustable depth of cut. Said ramp 7 will have sidewalls that will reduce over-spillage of material due to said conveyor belt of scoops 6.

As said conveyor belt of scoops 6 delivers said sea floor material to the top aft end of said ramp 7, said sea floor material will cascade down inside of the rotating mesh-walled drum 12, which is rotating in the direction 16, and is held in place by castors 14, where through rotating action from the motor and a means for conveying rotational energy 26 (FIG. 7), and the assistance of the inner fins 15, all medium and large sized unwanted gravel and rocks exit the lower aft portion of said mesh-walled drum 12, back to the sea floor. Due to gravity and rotational action, the much-desired gold ore falls through the mesh openings of said mesh-walled drum 12, and is deposited onto the inner surface of stationary shield 19.

Said rotating meshed-walled drum 12 has one or more externally mounted, flexible wiper blades 13 that will sweep the upper surface of the stationary shield 19, wiping all of the desired gold ore into trough 22. Screw conveyor 23, situated in said trough 22, spirally conveys said gold ore to the aft end of said trough 22, where said gold ore exits trough 22 as it is suctioned through the bottom aft opening 18, into the suction tube 17.

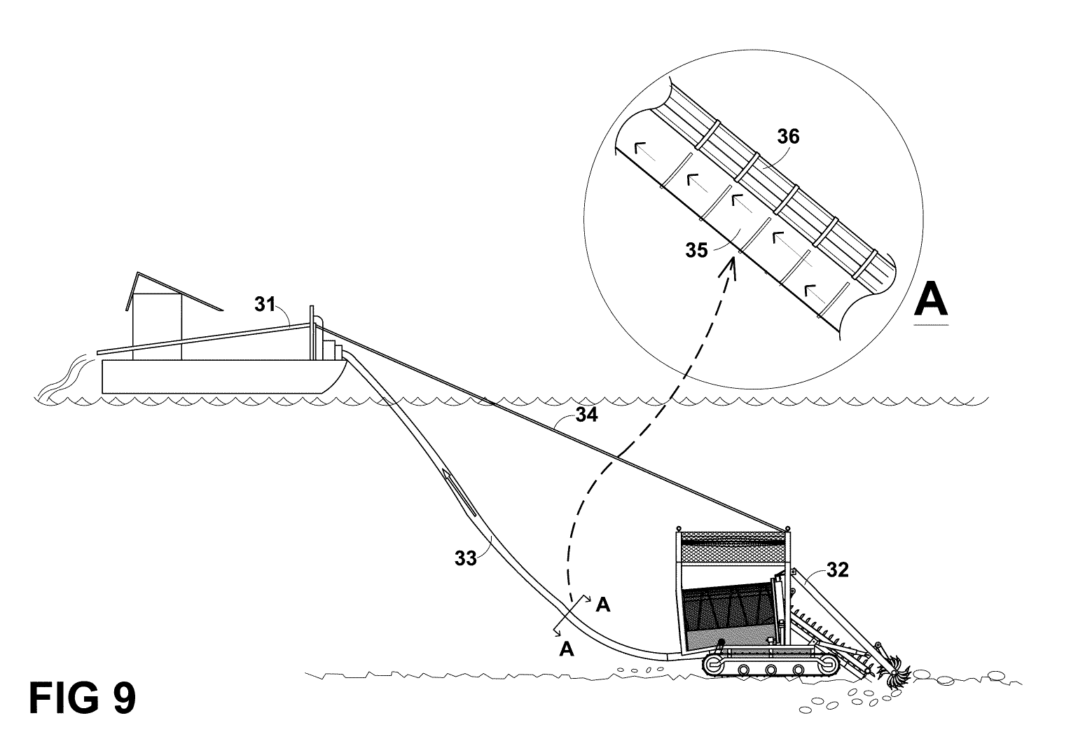

A suction hose 35 (FIG. 9—Image A) is attached to said suction tube 17. The inside region of said suction tube 17 and said bottom aft opening 18 are under a tremendous amount of suction, whereby said gold ore is transported to the dredge 31 (FIG. 9) on the water's surface, for further processing.

It is an object of my invention that when said operator is ready to retrieve said machine 32 (FIG. 9) he may cause to inflate an inflatable apparatus 10 located under frame member 11, and within the confinements of screened canopy 28. Said inflatable apparatus 10, when inflated with pressurized air, will give said machine 32 (FIG. 9) buoyancy during the retrieval process, but only up to the point where said inflatable apparatus 10 reaches the water's surface.

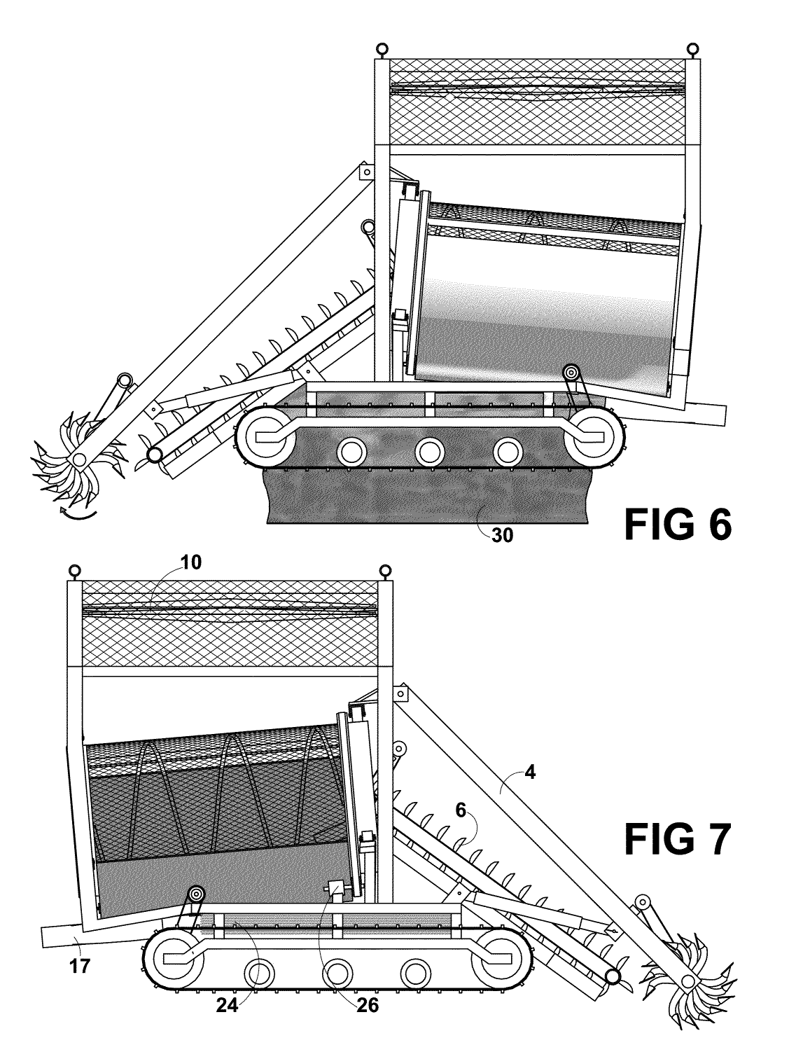

Winch cables attached to lifting hooks 9, affixed to said frame member 11, would experience a much greater lifting task if said inflatable apparatus 10 is raised above the water's surface. Therefore, prior to said inflatable apparatus 10 being raised above the waterline, said operator will then cause to inflate a second inflatable apparatus 30 (FIG. 6), which is situated beneath said chassis 21, and between said tracks 27. Said second inflatable apparatus 30 may be inflated such that it may completely support the entire weight of machine 32 (FIG. 9).

Obviously, initially inflating said inflatable apparatus 24, without inflating said upper inflatable apparatus 10 could very possibly flip the machine upside down. Inflatable apparatus 10 offers significant stability in the retrieval process by creating a pulling force at the top of said machine. By coordinating a simple process of inflating said air apparatuses 10 and 24 in their proper sequence, a safe and logical retrieval is achieved.

It is commonly known that water has a weight of 62.5 pounds/cubic foot. Therefore, each cubic foot of pressurized air pumped into said inflatable apparatuses 10 or 24 when underwater, will displace this water, and increase the machine's buoyancy by approximately 62.5 lb.

It is anticipated that said inflatable apparatus 24 may have a potential air volume capacity such that its buoyancy may be completely capable of supporting said machine's 32 (FIG. 9) entire weight, and therefore machine 32 may not need rely on the support vessel to carry its weight for transport. FIG. 6 embodies the inflated view of said inflatable apparatus 24, and displays the inflated view 30.

Said inflatable apparatuses 10 and 24 are key elements of my invention, and they enhance the profitability of the crew, due to the reduced need for a much larger support vessel. A smaller support vessel can operate in shallower water, and cost less to operate than a larger support vessel.

FIG. 9 is an embodiment of the complete view of said machine 32 and said support vessel 31 in operation. Blowup image A reveals a close-up view of the combination of hoses 33. Included in said combination of hoses 33, depicted by image A, is the assorted hydraulic hoses and air lines 36, in conjunction with suction hose 35, for said machine's 32 various functions. Said support vessel 31 is connected to machine 32 via tow cable 34, attached to said lifting hooks 9 (FIG. 3).

I claim:

1. An underwater machine for offshore gold prospecting, comprising:
a) a chassis, and
b) a means of said chassis for mounting a means for mobility, and
c) a mounted apparatus, wherein through said apparatus's operational movements, said apparatus will cause the dislodging and discard of large unwanted boulders from the machine's pathway, and
d) a means for gathering this now boulder-free, sea floor material, and
e) a means for classifying said boulder-free, sea floor material to retain the sought-after gold ore, and
f) a means allowing for the collection and transport of said boulder-free sea floor material to a support vessel for further processing.

2. A means of mobility of claim 1 wherein said mobility is crawler-style tracks with a means for each track to have propulsion in at least one direction of travel.

3. A means of mobility of claim 1 wherein said mobility is wheels with a means for propulsion.

4. The mounted apparatus of claim 1 comprising a rotating device that dislodges boulders and moves said boulders from said machine's pathway.

5. The mounted apparatus of claim 1 comprising a forward and rearward thrusting apparatus that dislodged said boulders and moves said boulders from the machine's pathway.

6. A gathering means of claim 1 comprising revolving scoops that capture said boulder-free sea floor material.

7. A gathering means of claim 1 comprising paddles that capture said boulder-free material.

8. A means of claim 1 for screening said boulder-free material to allow for the collection of the sought-after gold ore.

9. A means of claim 1 comprising a rotating mesh-walled drum for allowing said sought-after gold ore to fall through the mesh openings for capture.

10. A means of claim 1 wherein said sought-after gold ore is collected and then transported to a support vessel on the water's surface for further processing.

11. At least one inflatable apparatus affixed to said machine, wherein once inflated with pressurized air, said inflatable apparatus has the effect of increasing said machine's buoyancy, thereby reducing said machine's effective weight to said support vessel, when said machine needs to be raised to the water's surface.

12. An inflatable apparatus of claim 11 comprising a rubber bladder.

13. An inflatable apparatus of claim 11 comprising an expandable bellows.

14. An inflatable apparatus of claim 11 comprising two sold-surface sheets, sandwiching a flexible curtain membrane affixed to the perimeters of said solid-surface sheets, thereby creating an air-tight container, wherein if pressurized air is introduced to inside of said air-tight container, said air-tight container will inflate.

15. An apparatus of claim 11 comprising a sealed container for the purpose of adding buoyancy to said machine, when pressurized air is introduced into said sealed container.
